(19) United States
(12) Patent Application Publication
(10) Pub. No.: US 2023/0372921 A1
(43) Pub. Date: Nov. 23, 2023

(54) METHOD FOR FORMING A POROUS STRUCTURE, POROUS STRUCTURE AND USE

(71) Applicant: TEKNOLOGIAN TUTKIMUSKESKUS VTT OY, Espoo (fi)

(72) Inventors: Tomi Lindroos, Tampere (FI); Timo KINOS, Tampere (FI); Kimmo KAUNISTO, Tampere (FI); Pekka SIMELL, Tampere (FI); Ilkka HANNULA, Tampere (FI)

(21) Appl. No.: 18/246,840

(22) PCT Filed: Sep. 29, 2021
(86) PCT No.: PCT/FI2021/050639

§ 371 Date: Mar. 27, 2023

(30) Foreign Application Priority Data
Oct. 1, 2020 (FI) 20205960

(51) Int. Cl. B01J 37/00; B01J 37/08; B01J 35/10

(52) U.S. Cl. CPC B01J 37/0018; B01J 37/08; B01J 35/1076

(57) ABSTRACT

The invention relates to a method for forming a porous structure with a catalyst, wherein an organic space holder material is coated with at least one catalytic material to form a coated organic space holder material, the coated organic space holder material is mixed with a carrier material to form a mixture, and the organic space holder material is removed and the mixture in sintered to form the porous structure with the catalyst. Further, the invention relates to the porous structure and use of the porous structure obtained by the method.

### FIELD

The application relates to a method defined in claim 1 and a porous structure defined in claim 13. Further, the application relates to a use of the porous structure obtained by the method defined in claim 16.

### BACKGROUND

Known from the prior art is to catalyst structures from different catalysts. Typically, catalytic surfaces produced by dip or wash coating techniques where slurry comprising catalytic component is deposited onto supports. Both dip and wash coating techniques are limited to structures where the slurry can be applied smoothly. Due to nature of these techniques, small internal cavities and pores with size below 500 μm are difficult to coat.

### OBJECTIVE

The objective is to solve the above problems. Further, the objective is to disclose a new type porous structure. Further, the objective is to disclose a new type method for forming a porous structure. Further, the objective is to disclose a structure which can be electrically heated. Further, the objective is to disclose a catalytic structure with small pores.

### SUMMARY

The method and porous structure and use are characterized by what are presented in the claims.

In the method a porous structure which comprises a catalyst is formed from a mixture comprising carrier material and a catalytic material. Further, a porous auxiliary substance is used in the mixture during the production.

The porous structure which comprises a catalyst is provided as a product.

### DETAILED DESCRIPTION

In a method for forming a porous structure with a catalyst, the method comprises coating an organic space holder material with at least one catalytic material to form a coated organic space holder material, mixing the coated organic space holder material with a carrier material to form a mixture, and removing the organic space holder material and sintering the mixture to form the porous structure with the catalyst. Then the porous structure with a desired porous can be produced.

In this context, the catalyst means any suitable catalyst which comprises catalytic material. The catalyst may be formed from one or more catalytic material. The catalytic material may be formed one or more components, agents and/or compounds. In one embodiment, the catalyst comprises one catalytic material layer. In one embodiment, the catalyst comprises at least two catalytic material layers. In one embodiment, the catalyst comprises at least two catalytic material layers formed from the same catalytic material. In one embodiment, the catalyst comprises catalytic layers of at least two catalytic materials. In one embodiment, the catalyst comprises at least metal, ceramic material, composite material and/or their combination. In one embodiment, the catalyst consists of metal, ceramic material, composite material or their combination. In one embodiment, the catalytic material comprises at least one metal agent which may be selected from the group consisting of Ni, Co, Fe, Rh, Pt, Pd, other suitable metal or noble metal, or their compounds or their combinations. In one embodiment, the catalytic material comprises at least one catalytic agent, e.g. any suitable catalytic agent. The catalytic agent or metal agent may be a precursor of the catalytic material or catalyst. In one embodiment, the catalytic material is in a form of powder, or alternatively in other suitable form.

In this context, the organic space holder material means any suitable organic material which can be removed from the mixture. In one embodiment, the organic space holder material consists of beads, e.g. balls, pellets, granules, particles, rods or fibers, which have desired size. In one embodiment, sizes of the beads vary. For example, the size of the beads may be below 500 μm, in one embodiment below 150 μm, in one embodiment below 100 μm, and in one embodiment below 50 μm. In one embodiment, the organic space holder material is formed from polymer material, plastic, polymer-based material, other organic material or their combinations. In one embodiment, the organic space holder material is formed from thermoplastic material. In one embodiment, the organic space holder material comprises PMMA (polymethylmetacrylate), derivates of PMMA, polypropylene, derivates of polypropylene or their combinations.

In this context, the carrier material means any suitable carrier material which can be used in the porous structure. In one embodiment, the carrier material is in the form of powder. In one embodiment, the carrier material is selected from metal, ceramic material, alloy or their combinations. In one embodiment, the carrier material comprises at least metal. In one embodiment, the carrier material is the alloy. In one embodiment, the carrier material is the FeCrAl-alloy. Alternatively, the carrier material may have any suitable composition.

In one embodiment, the organic space holder material is coated with at least one catalytic material. In one embodiment, the organic space holder material is coated with at least one catalytic material such that at least one layer of the catalytic material is coated onto the surface of the organic space holder material, e.g. onto the surface of the organic space holder material beads. Any suitable coating method may be used for coating the organic space holder material.

In one embodiment, the mixing for forming the mixture is performed in a mixing device, e.g. in a compounder, extruder, batch mixer or other mixer. In one embodiment, the mixing is performed in a compounder, e.g. a double-screw compounder or twin-screw compounder. In one embodiment, the mixing is performed in an extruder, e.g. a twin-screw extruder. The mixture can be heated during the mixing. In one embodiment, the mixing is performed at temperature of 150-250° C., in one embodiment at temperature of 170-210° C. In one embodiment, the mixing is performed at the above temperature, when the mixture comprises the coated organic space holder material and the carrier material. In one embodiment, the mixing is performed at the above temperature, when the mixture comprises the coated organic space holder material and the carrier material and further a binder. In one embodiment, the mixture is arranged to a predetermined shape, e.g. by extruding through a nozzle or extrusion head or by an injection moulding, for forming a desired structure in connection with the mixing. In one embodiment, the mixture is arranged to a predetermined shape after the mixing. In one embodiment, the mixture is extruded in an extruder after the mixing for giving a desired shape of the structure. In one embodiment, a desired shape to the structure may be made by an injection moulding by treating the mixture after the mixing. In one embodiment, the mixture is cooled after the mixing and after that the cooled mixture is treated in order to give a desired shape of the porous structure. In one embodiment, the mixture is cooled after the mixing, the cooled mixture is crushed or granulated, and after that the granules of the cooled mixture are treated, e.g. in an extruder or injection moulding, in order to give a desired shape of the porous structure. In one embodiment, the shape of the porous structure is a tube, bar, channel, sheet, plate or other shape. In one embodiment, the mixture is heated or partially melted in connection with the shaping.

In one embodiment, the mixture comprises at least one binder. In this context, the binder means any binder which is suitable to be used in the production of the porous structure. The binder may contain one or more binder component. In one embodiment, the binder contains at least one component selected from the group consisting of POM-polymer (polyacetal), paraffin wax, stearic acid, other binder or their combinations. In one embodiment, the binder contains POM-polymer (polyacetal) and paraffin wax. In one embodiment, the binder contains POM-polymer (polyacetal), steric acid and paraffin wax. In one embodiment, the binder contains at least paraffin wax. In one embodiment, the binder is needed if the shape of the structure is provided in the shaping, e.g. by extruding or by injection moulding.

In one embodiment, the binder is added to the mixture. In one embodiment, the binder is added to the carrier material or the coated organic space holder material before the mixing. In one embodiment, the binder is added during the mixing. In one embodiment, the binder is fed to the mixing, e.g. to the mixing device. In one embodiment, the carrier material, the coated organic space holder material and the binder are mixed in the mixing to form the mixture.

Amounts of the coated organic space holder material and carrier material, and optionally the binder, may be varied in the mixture. In one embodiment, the mixture comprises the organic space holder material 40-80 vol-%, in one embodiment 50-70 vol-% and in one embodiment 55-65 vol-%. In one embodiment, the mixture comprises the carrier material 5-30 vol-%, in one embodiment 10-27 vol-% and in one embodiment 15-25 vol-%. In one embodiment, the mixture comprises the binder, and an amount of the binder is 5-30 vol-%, in one embodiment 10-27 vol-% and in one embodiment 15-25 vol-%.

In one embodiment, the formed mixture is treated by debinding, e.g. thermal debinding, catalytic debinding or solvent or water debinding, or by a binder removal before the sintering. In one embodiment, the organic space holder material is removed, at least partly, during the debinding or the binder removal. For example, the the organic space holder material may be combusted during the thermal debinding.

The formed mixture is sintered, after the debinding or binder removal or after the mixing and/or shaping without the debinding or binder removal. In one embodiment, the formed mixture is sintered such that the organic space holder material or a rest of the organic space holder material is removed during the sintering or in the beginning of the sintering. In one embodiment, the organic space holder material is removed by combusting during the sintering. In one embodiment, the sintering is performed at temperature of 900-1500° C., in one embodiment at temperature of 1000-1300° C. and in one embodiment at temperature of 1100-1200° C. In one embodiment, the sintering is performed at temperature of 1150-1230° C.

When the organic space holder material is removed, e.g. by combusting, from the structure, the carrier material and the catalytic material remain in the structure. Then pores form into the structure, and the porous structure can be provided.

In one embodiment, the porous structure is treated catalytically such that a catalytic coating is arranged onto the surface of the porous structure, e.g. during the sintering. The catalytic coating can be formed from the catalytic material or other suitable catalyst.

The porous structure is a product which is obtained by the method described above. The porous structure comprises pores, preferably after the sintering. Preferably, the pores of the porous structure have the catalyst surface on the surfaces of the pores after the sintering. In one embodiment, the porous structure comprises the pores, and the diameter of the pores is below 500 μm. In one embodiment, the diameter of the pores is below 150 μm, e.g. 1-150 μm or 100-150 μm. In one embodiment, the diameter of the pores is below 100 μm, e.g. 1-100 μm or 50-100 μm or 30-70 μm. In one embodiment, the diameter of the pores is below 50 μm, e.g. 1-50 μm. In one embodiment, the porous structure has high specific surface area. In one embodiment, the porous structure is electrically conductive. In one embodiment, the catalyst of the porous structure or at least a part of the catalyst is electrically conductive. The porous structure may be heated electrically, such as resistively or inductively. In one embodiment, the porous structure is a heat-resistant structure, and the porous structure resists temperature of 600-1400° C.

In one embodiment, the method and the porous structure can be used to produce the porous structures and/or catalyst structures for desired reactions. In one embodiment, the porous structure can be used in chemical reactors, heating elements, heat structures or their combinations. In one embodiment, the porous structure may be utilized in resistive heating element or in inductive heat structure. In one embodiment, the porous structure may be utilized in different chemical and/or catalytical reactors.

Thanks to the invention, the porous structure with desired pore structure and with controlled porosity can be produced. Reactive surface area in the porous structure can be maximized. Further, the porous structure is a heat-resistant structure.

The porous structure can be heated electrically, and thus chemical reactors can be heated electrically. Thanks to the invention heat transfer to catalytic surface can be maximized. Then more compact size reactors can be provided.

The method and porous structure offer a possibility to produce the porous structure with the catalyst easily and cost-effectively for different industrial applications and reactors. In the industrial process different streams, e.g. gas flows, can flow easily through the porous structure, and effect reactions can be provided in the porous structure.

### EXAMPLES

Example 1 presents some embodiments of the method for producing a porous structure.

### Example 1

In this example, the porous structure was formed.

An organic space holder material, which consists of PMMA beads (diameter about 50 μm, density 0.70 g/cc), was selected. The beads of the organic space holder material were coated with a catalytic material to form a coated organic space holder material. The catalytic material contained a metal catalytic agent selected from Ni in the first composition, from Co in the second composition and from Fe in the third composition.

The coated organic space holder material was mixed with a carrier material powder and a binder to form a mixture in a twin-screw compounder. The carrier material was FeCrAlalloy (density 7.2 g/cc). The binder contained POM-polymer (density 1.42 g/cc) and paraffin wax (density 1 g/cc). The composition of the mixture was: 60 vol-% PMMA beads, 5 vol-% wax, 15 vol-% POM-polymer and 20 vol-% FeCrAl-alloy. The mixing was performed at temperature of about 190° C. After the mixing, the mixture was cooled, and after that crushed and granulated.

The granulates of the mixture material was fed to an extruder in which the material was heated and melted, and a structure, e.g. a tube or plate, was shaped from the granulates.

The formed structure was treated by a catalytic debinding, wherein the POM binder was removed. The removal of the binders and the organic space holder material is finalized during a thermal debinding in beginning of sintering process. The structure was sintered at temperature of about 1200° C. to form the porous structure with the catalyst. A rest of the organic space holder material may be removed by combusting in beginning of the sintering. When the organic space holder material is removed from the structure, pores form in the structure, and then the porous structure can be provided with a desired porous.

From the test it was observed that the porous and resistant structure with high porous and with high surface area can be produced.

The compounder, extruder and sintering device and other devices and equipments of the process used in Example 1 are known per se in the art, and therefore they are not described in any more detail in this context.

The method is suitable in different embodiments for forming different porous structures. The porous structure is suitable in different embodiments for using in different processes.

The invention is not limited merely to the examples referred to above; instead many variations are possible within the scope of the inventive idea defined by the claims.

1. A method for forming a porous structure with a catalyst, wherein the method comprises the steps
coating an organic space holder material with at least one catalytic material to form a coated organic space holder material,
mixing the coated organic space holder material with a carrier material and a binder to form a mixture and the mixing is performed at temperature of 150-250° C., and
removing the organic space holder material and sintering the mixture to form the porous structure with the catalyst.

2. (canceled)

3. The method according to claim 1, wherein the mixture is arranged to a predetermined shape for forming a desired structure.

4. The method according to claim 1, wherein the mixture is cooled after the mixing, the cooled mixture is crushed or granulated, and after that the granules of the cooled mixture are treated in order to give a desired shape of the structure.

5. The method according to claim 1, wherein the catalyst comprises at least metal, ceramic material, composite material and/or their combination.

6. The method according to claim 1, wherein the organic space holder material consists of beads.

7. The method according to claim 1, wherein the organic space holder material is formed from thermoplastic material.

8. The method according to claim 1, wherein the organic space holder material comprises PMMA (polymethylmetacrylate), derivates of PMMA, polypropylene, derivates of polypropylene or their combinations.

9. The method according to claim 1, wherein the carrier material is selected from metal, ceramic material, alloy or their combinations.

10. (canceled)

11. The method according to claim 1, wherein the binder contains at least one component selected from the group consisting of POM-polymer (polyacetal), paraffin wax, stearic acid, other binder or their combinations.

12. The method according to claim 1, wherein the mixture is treated by debinding or by a binder removal before the sintering.

13. A porous structure with a catalyst, wherein
the porous structure is produced by coating an organic space holder material with at least one catalytic material to form a coated organic space holder material, by mixing the coated organic space holder material with a carrier material and a binder to form a mixture in which the mixing is performed at temperature of 150-250° C., and by removing the organic space holder material and sintering the mixture to form the porous structure with the catalyst, and
the porous structure comprises pores, and the diameter of the pores is below 500 μm.

14. The porous structure according to claim 13, wherein the diameter of the pores is below 100 μm.

15. The porous structure according to claim 13, wherein the diameter of the pores is below 50 μm.

16. A use of the porous structure obtained by the method according to claim 1, wherein the porous structure is used in chemical reactors, heating elements, heat structures or their combinations.
